(19) United States
(12) Patent Application Publication
(10) Pub. No.: US 2008/0140390 A1
(43) Pub. Date: Jun. 12, 2008

(54) SOLUTION FOR SHARING SPEECH PROCESSING RESOURCES IN A MULTITASKING ENVIRONMENT

(75) Inventor: MING XIA, NANJING (CN)

Correspondence Address: PATENTS ON DEMAND, P.A., 4581 WESTON ROAD, SUITE 345, WESTON, FL, 33331, US

(73) Assignee: MOTOROLA, INC., SCHAUMBURG, IL (US)

(21) Appl. No.: 11/608,935

(22) Filed: Dec. 11, 2006

(51) Int. Cl. G06F 17/21; G10L 15/00; G06F 9/46

(52) U.S. Cl. 704/10; 718/107; 704/251; 704/E15.001

(57) ABSTRACT

A system for sharing computing resources including a multi-tasking environment within which a multiple of speech-enabled applications concurrently execute. The system can include a speech resource manager configured to receive speech based requests from the applications, to associate these requests with the requesting application, to use a set of speech resources to produce results for the requests, and to deliver the results to a requesting application. The speech resource manager permits each concurrently executing speech-enabled application to utilize the speech resources. In one embodiment, the system can be a mobile communication device that includes a wireless transceiver configured for real-time communications. When implementing the system in a mobile communication device, the multitasking environment can be a virtual machine environment. such a JAVA MICRO EDITION PLATFORM (J2ME) environment.

### BACKGROUND

1. Field of the Invention

The present invention relates to speech processing and, more particularly, to a solution for sharing speech processing resources in a multitasking environment.

2. Description of the Related Art

Many resource limited devices lack robust peripherals, which are common for their desktop counterparts. For example, while many personal data assistants (PDAs), smart phones, and entertainment devices are computationally powerful devices, these devices generally possess small and inconvenient display screens, tiny keypads, pointing devices, and the like, which make user interactions difficult. To compensate, these devices often make extensive use of speech processing technologies, which provide an intuitive interaction interface having a small physical footprint. Further, speech based interfaces permit users to operate a device in a hands-free fashion without visual focus so that other actions, such as driving, can be performed with minimal distraction.

At present, many conventional computing environments utilize resource blocking techniques that prevent concurrent use of speech processing resources by applications executing within the environment. For example, conventional implementations of a J2ME VM do not permit more than one speech-enabled MIDLET to concurrently utilize speech resources. This represents a major limitation, which prevents voice interactions with multiple active applications, such as preventing a user from accessing a phone book using voice commands when a voice-enabled navigation application is executing.

### SUMMARY OF THE INVENTION

The present invention establishes a speech resource manager that handles interactions between multiple speech-enabled applications and a shared set of speech processing resources. Tasks requiring a speech resource are submitted to the speech resource manager by each speech-enabled application, which returns speech processing results to the submitting application. The speech resource manager prevents each speech-enabled application from exclusively seizing a device's speech resources. The invention permits multiple speech-enabled applications to concurrently operate in a multi-tasking environment.

In one embodiment, the speech resource manager can separately control different types of speech resources, permitting each resource type to be concurrently used by a different speech-enabled application. For example, a microphone can be used to capture speech input for one application, while a speech recognition engine can execute a process for a different application. One configuration of the speech resource manager can include a speech resource controller, a grammar/words controller, a result/event controller, and the like.

The present invention can be implemented in accordance with numerous aspects consistent with the material presented herein. One aspect of the present invention can include a system for sharing computing resources including a multi-tasking virtual environment within which a multiple of speech-enabled applications can concurrently execute. The system can include a speech resource manager configured to receive speech based requests from the applications, to associate these requests with the requesting application, to use a set of speech resources to produce results for the requests, and to deliver the results to a requesting application. The speech resource manager permits each concurrently executing speech-enabled application to utilize the speech resources. In one embodiment, the system can be a mobile communication device that includes a wireless transceiver configured for real-time communications. For example, the system can be a mobile telephone or a navigation system. When implementing the system in a mobile communication device, the multitasking environment can be a virtual machine environment, such a JAVA MICRO EDITION PLATFORM (J2ME) environment.

Another aspect of the present invention can include a method for sharing speech resources among a plurality of speech-enabled applications. In the method, multiple speech-enabled applications can convey resource allocation/deallocation requests to a resource controller. The resource controller can automatically allocate/deallocate a set of shared speech resources based upon requests received from the speech-enabled applications. Speech processing operations can be performed for the speech-enabled applications using the set of shared speech resources. Results and events produced by the performing step can be delivered to applicable ones of the speech-enabled applications.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram showing a system in which multiple concurrently executing speech-enabled applications share speech processing resources using a speech resource manager.

FIG. 2 is a schematic diagram of a system illustrating components of a speech resource manager that permits speech-enabled applications to concurrently share a set of resources in accordance with an embodiment of the inventive arrangements disclosed herein.

FIG. 3 is a flow diagram illustrating a speech resource manager concurrently providing speech resources to multiple speech-enabled applications in accordance with an embodiment of the inventive arrangements disclosed herein.

FIG. 4 is a schematic diagram of a grammar/words controller in accordance with an embodiment of the inventive arrangements disclosed herein.

FIG. 5 is a schematic diagram of a result/event controller in accordance with an embodiment of the inventive arrangements disclosed herein.

FIG. 6 is a schematic diagram of a resource controller in accordance with an embodiment of the inventive arrangements disclosed herein.

### DETAILED DESCRIPTION OF THE INVENTION

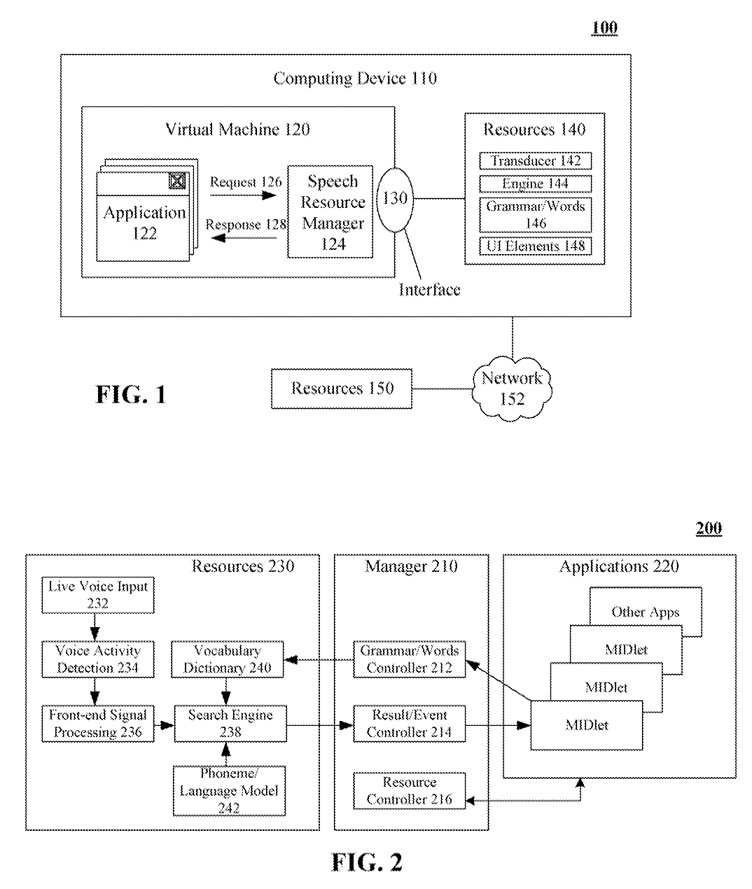

FIG. 1 is a schematic diagram showing a virtual machine (VM) 120 in which multiple concurrently executing speech-enabled applications 122 share speech processing resources 140 using a speech resource manager 124. The VM 120 can execute in a computing device 110 having a set of local resources 140, which can be used by the applications 122, which typically access the resources 140 via interface 130. The interface 130 can be an application program interface (API), a runtime library, and any other software construct that permits one or more of the resources 140 to be utilized from within the virtual machine 120.

Resources 140 can include, but are not limited to, at least one transducer 142 (e.g., a microphone for receiving speech input and/or a speaker for presenting speech output), one or more speech processing engines 144 (e.g., a speech recognition engine and/or a speech generation engine), one or more speech grammars and/or sets of words 146 that are used for speech processing purposes, shared user interface 148 elements (e.g., focus determination and event handling elements), and the like.

Each speech-enabled application 122 can submit a processing request 126 to the speech resource manager 124. The speech resource manager 124 can access necessary resources 140 through interface 130 and use these resources 140 to generate a response 128, which is conveyed to the application 122 that originally issued the request 126.

Traditional VM implementations directly access resources 140 via interface 130 thereby making these resources unavailable to other applications. The use of the speech manager 126 as an intermediary or resource broker permits otherwise exclusive resources to be concurrently shared among speech-enabled applications 122. In one embodiment, one or more remote speech resources 150 accessible via network 152 can be used instead of local resources 140, depending upon device 110 configuration.

As used herein, the device 110 can be any hardware/software combination upon which the virtual machine 120 resides. The device 110 can include, but is not limited to, a mobile telephone, a notebook computer, a tablet computer, a desktop computer, a wearable computer, an embedded computer, a mobile email appliance, a media player, an entertainment system, and the like.

The VM 120 can be a software-defined computing environment that executes upon a hardware platform of device 110. The VM 120 can include an instruction set, a set of registers, a stack, a garbage-collection heap, and an area for storing methods. In one embodiment, the VM 120 can be specifically tailored for resource-constrained devices, such as mobile telephones. In another embodiment, the VM 120 can interpret and execute bytecode. In one configuration, the VM 120 can be a JAVA VM, such as a JAVA 2 ENTERPRISE EDITION (J2EE) VM or a JAVA 2 MICRO EDITION (J2ME) VM.

Each speech-enabled application 122 can be an application that processes speech input and/or generates speech output. Depending upon VM 120 implementation specifics, application 122 can be an APPLET, a MIDLET, and any other application type suitable for execution within the VM 120.

Network 152 can include any hardware/software/and firmware necessary to convey digital content encoded within carrier waves. Content can be contained within analog or digital signals and conveyed through data or voice channels. The network 152 call include local components and data pathways necessary for communications to be exchanged among computing device components and between integrated device components and peripheral devices. The network 152 can also include network equipment, such as routers, data lines, hubs, and intermediary servers which together form a packet-based network, such as the Internet or an intranet. The network 152 can further include circuit-based communication components and mobile communication components, such as telephony switches, modems, cellular communication towers, and the like. Tile network 152 can include line based and/or wireless communication pathways.

It should be appreciated that the arrangements shown in system 100 are for illustrative purposes and that derivatives and alternative embodiments are contemplated. In one embodiment, applications 122 and speech resource manager 124 can execute directly upon a computing device 110 and not from within VM 120. In another embodiment, one or more of the resources 140 shown as external to the VM 120 can be resources implemented inside the VM 120. Further, although manager 124 is shown as separate from interface 130, these two components of system 100 are able to be combined. For example, manager 124 can be part of an interface class, which extends capabilities of a more limited class (e.g., interface 130), which lacks a capability to concurrently share speech resources 140. In another example, the speech resource manager 124 can represent (or utilize) all extension to the JAVA SPEECH API, which again permits applications 122 to share resources 140.

FIG. 2 is a schematic diagram of a system 200 illustrating components of a speech resource manager 210 that permits speech-enabled applications 220 to concurrently share a set of resources 230 in accordance with an embodiment of the inventive arrangements disclosed herein.

Resource controller 216 can manage allocations and deallocations of resources 230 for manager 210. Further, the resource controller 216 can be used to determine which application 220 is associated with a shared resource 230 in situations where shared resources 230 and/or results generated by the resources 230 can be dispatched to more than one different application 220. Grammar/words controller 212 can constrain a speech recognition space to an applicable set of words/phrases. Results/event controller 214 routes speech processing results and/or events directed towards one or more applications 220 to the proper application 220.

A speech recognition example is shown to illustrate interactions among components 210-230. Live speech input 232 can be received by one of the resources 230 (e.g., a microphone). The input can be automatically identified as including speech, which triggers a voice activity detection 234 event. Front end signal processing 236 can be performed by digital signaling processing (DSP) resources 230. A vocabulary dictionary 240 can be constructed from a set of words/phrases provided by the grammar/words controller 212. The dictionary 240 can be used by the search engine 238 to speech recognize the speech input. The conversion can be based upon a phoneme/language model 242. Results produced by engine 238 can be conveyed to the results event controller 214, which in turn conveys the results to a suitable application 220.

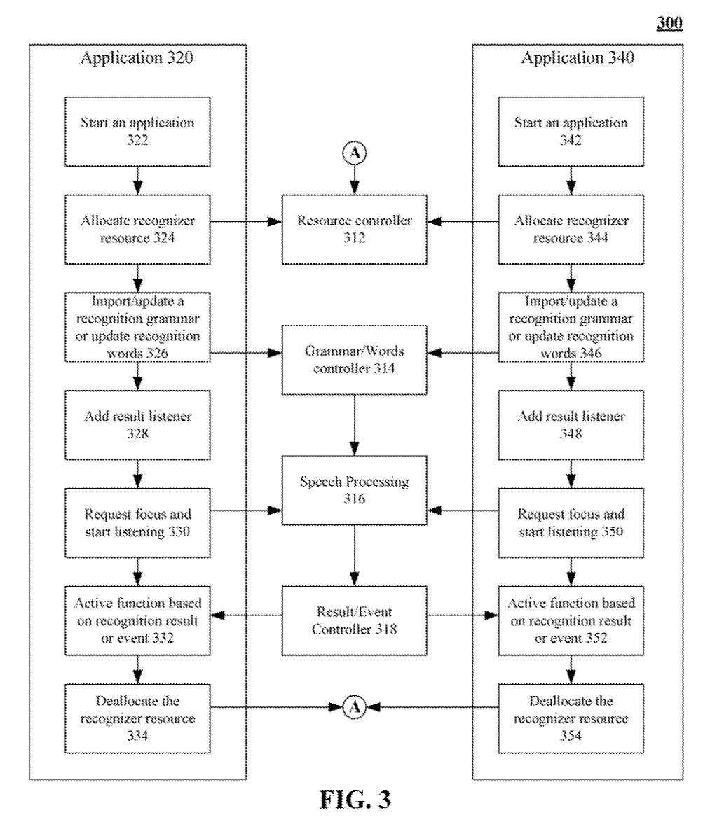

FIG. 3 is a flow diagram 300 illustrating a speech resource manager 310 concurrently providing speech resources to multiple speech-enabled applications 320 and 340 in accordance with an embodiment of the inventive arrangements disclosed herein.

Diagram 300 shows two concurrently executing applications 320 and 340, both of which utilize speech resources. The applications 320, 340 can be speech-enabled applications executing within a VM. Each application 320, 340 can be instantiated in step 322, 342. A request to allocate speech processing resources 324, 344 can be made during start-up, which is sent to the resource controller 312. The resource controller 312 can manage allocation/deallocation of a common set of speech resources for both applications 320, 340.

As it executes, each application 320, 340 can establish and/or update a recognition grammar and/or set of words to be used as a speech recognition search space in step 326, 346. As application 320, 340 context changes, the grammar/words can dynamically change. The grammar/words controller 314 can maintain a current recognition search space for each application 320, 340. Listeners for speech processing events can be added in step 328, 348. In step 330, 350 focus can be requested by one or both of the applications 320-340, and an application specific listener can begin listening. A speech processing task for one of the applications 320, 340 can be performed in step 316, which produces results and/or events, that are conveyed to controller 318. The speech processing task can utilize a specific grammar/set of words designated by controller 314.

The controller 318 can determine which application 320, 340 is to receive the result/event. Once this determination is made, events/results can be broadcasted or otherwise conveyed to the appropriate application 320, 340. Because of the use of the listeners, it is possible for controller 318 to direct a particular event/result to multiple applications 320, 340 or to a single application 320, 340. Upon receiving the results/events, a targeted application 320, 340 can perform a programmatic action or set of programmatic actions based upon these results/events, as shown by step 332, 352. The application 320, 340 can deallocate a shared resource 334-354, once it is no longer required. A deallocation command can be submitted to the resource controller 312, which deallocates the resource, unless it is in use by another one or the applications 320, 340.

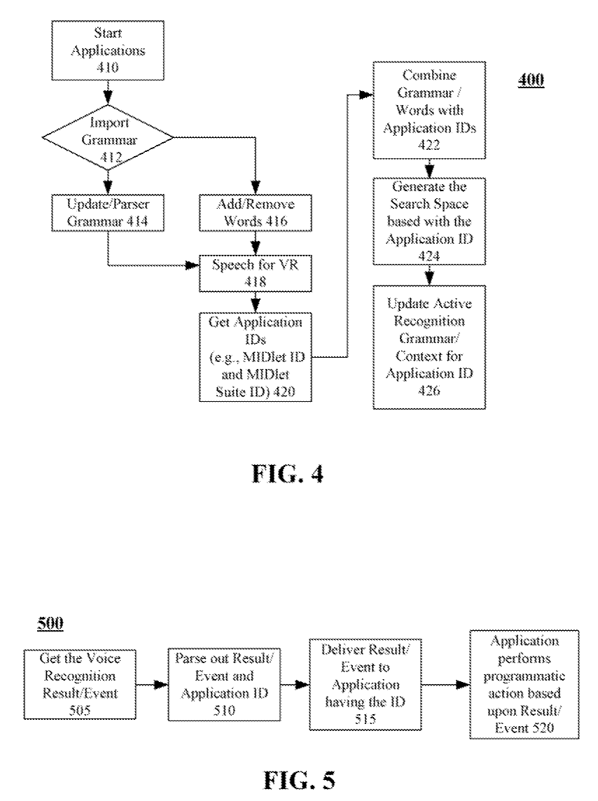

FIG. 4 is a schematic diagram of a grammar/words controller 400 in accordance with an embodiment of the inventive arrangements disclosed herein. The controller 400 can be one implementation for controller 212 of system 200.

As shown, the grammar/words controller 400 can start applications 410, at which point it can import 412 or receive information from one or more speech-enabled applications relating to a set of active speech recognition words, which represents an application-specific recognition search space. Depending upon implementation specifics, the speech-enabled applications, the search space can specify either a grammar 414 or a set of words 416. The grammar 414 can be updated/parsed/activated as necessary. Alternatively, the set of words 416 can be dynamically added/removed from a previously established list as necessary. Either way, a search space for voice recognition purposes can be established 418.

The controller 400 can acquire application IDs in step 420, which it uses to associate a recognition search space with a corresponding speech-enabled application in step 422. This search space can be generated in step 424. Step 426 can update a grammar/set of words used by shared speech recognition resource, so that speech recognition processes are performed against input and are based upon an appropriate search space or grammar/set of words.

FIG. 5 is a schematic diagram of a result/event controller 500 in accordance with an embodiment of the inventive arrangements disclosed herein. The controller 500 can be one implementation for controller 214 of system 200.

The result/event controller 500 can acquire a voice recognition result and/or event 505 from a shared resource. Controller 500 can then determine one or more applications to which the result/event relates. In one embodiment, results can include application identifiers, which the controller 510 can parse out of received messages. In step 515, the results/events can be delivered to applications having appropriate identifiers. In step 520, the receiving application can perform programmatic actions based upon the results/event.

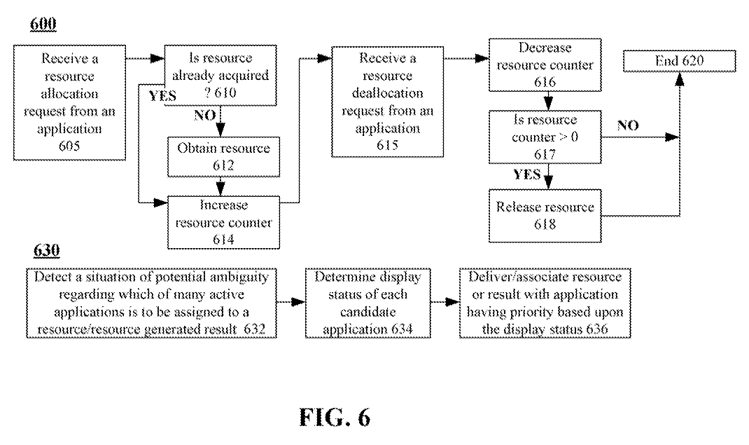

FIG. 6 is a schematic diagram of a resource controller in accordance with an embodiment of the inventive arrangements disclosed herein. The controller can be one implementation for controller 216 of system 200. Two different capabilities 600 and 630 possessed by the controller are illustrated. Capability 600 illustrates a resource allocation/deallocation capability of a resource controller. Capability 630 illustrates how a resource controller can be used to resolve conflicts, when input/output received/produced by shared resources can possibly apply to multiple applications, yet is intended for only one application.

When capability 600 is utilized, the resource controller can receive a resource allocation request from an application 605. Then, a check 610 can be performed to determine if the requested resource has already been acquired by controller for another application. If not acquired, the resource can be obtained in step 612. In step 614, a resource counter 614 can be increased. In step 615, a resource deallocation request can be received from an application. This can result in a resource counter 616 being decreased for that resource. In step 617, if the counter is zero the shared resource can be released 618 by the controller. The deallocation process can end in step 620.

When capability 630 is utilized, the resource controller can detect a situation 632 of potential ambiguity regarding which of many active applications is to be receiving a shared resource. In step 634, a display status can be determined for each candidate application competing for control of the shared resource. In a configuration where competing applications are MIDLETS, the different display statuses can include foreground, visible, and background, where foreground generally has the greatest priority and background has the least priority. In step 636, the shared resource can be delivered to the application having the highest priority based upon the display status. For instance, if two MIDLETS are competing for a shared resource and one has a foreground status and a second has a background status, then the foreground status MIDLET will be selected.

For example, Application A and B can both have some common recognition content. In a worse case scenario, where B is a copy of A, the recognition content of Application A and B can be identical. Assume a voice command “Open xx file” is said by a user, which could apply to either Application A or Application B, both of which are concurrently executing on a hypothetical system. Shared resources could potentially interpret the command as [Open xx file, ID_A] for Application A or as [Open xx file, ID_B] for Application B. The resource controller can determine which of Application A and B is to be associated with the voice command of “Open xx file” by preferring the application that has the greater canvas status priority.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A system for sharing computing resources comprising:
a multi-tasking environment within which a plurality of speech-enabled applications concurrently execute; and
a speech resource manager configured to receive speech based requests from the applications, to associate these requests with the requesting application, to use a set of speech resources to produce results for the requests, and to deliver the results to a requesting application, and wherein the speech resource manager permits each concurrently executing speech-enabled application to utilize the speech resources.

2. The system of claim 1, wherein the speech resource manager comprises:
a resource controller configured to receive allocation and deallocation requests for resources from each of the speech-enabled applications and to selectively obtain and release the requested resources from a shared resource pool.

3. The system of claim 1, wherein the speech resource manager comprises:
a grammar/words controller configured to dynamically change a search space used for speech recognition purposes for the plurality of speech-enabled applications, wherein the search space includes at least one entry for each valid entry for any of the speech-enabled applications in accordance with current application states of the speech-enabled applications.

4. The system of claim 1, wherein the speech resource manager comprises:
a result/event controller configured to capture results and events associated with the set of speech resources and to convey these results and events to appropriate ones of the speech-enabled applications.

5. The system of claim 1, wherein the environment is disposed within a resource-constrained, embedded consumer product, said consumer product including at least one of a mobile telephone, a personal data assistant, a navigation system, a media player, and an entertainment console.

6. The system of claim 1, wherein the multitasking environment is an environment of a virtual machine that interprets and executes bytecode.

7. The system of claim 6, wherein the virtual machine conforms to standards based upon a JAVA MICRO EDITION PLATFORM, and wherein each of the speech-enabled applications is a MIDlet.

8. The system of claim 1, wherein the speech resource manager executes within a virtual machine, wherein at least a portion of the speech resources execute outside the virtual machine.

9. The system of claim 8, wherein at least a portion of the speech resources are resources remote from a device upon which the virtual machine executes, said portion being processed via a network.

10. The system of claim 8, wherein the speech resource manager utilizes a speech application program interface (API) to access the speech resources, wherein said API lacks an inherent capability for permitting the speech-enabled applications to simultaneously access the speech resources.

11. A mobile communication device comprising:
a wireless transceiver configured for real-time communications;
a multi-tasking virtual machine within which a plurality of speech-enabled applications concurrently execute; and
a speech resource manager configured to receive speech based requests from the applications, to associate these requests with the requesting application, to use a set of speech resources to produce results for the requests, and to deliver the results to a requesting application, and wherein the speech resource manager permits each concurrently executing speech-enabled application to utilize the speech resources.

12. The system of claim 11, wherein the speech resource manager comprises:
a resource controller configured to receive allocation and deallocation requests for resources from each of the speech-enabled applications and to selectively obtain and release the requested resources from a shared resource pool;
a grammar/words controller configured to dynamically change a search space used for speech recognition purposes for the plurality of speech-enabled applications, wherein the search space includes at least one entry for each valid entry for any of the speech-enabled applications in accordance with current application states of the speech-enabled applications; and
a result/event controller configured to capture results and events associated with the set of speech resources and to convey these results and events to appropriate ones of the speech-enabled applications.

13. The device of claim 11, wherein the mobile communication device is a mobile telephone.

14. The device of claim 11, wherein the mobile communication device is a navigation system.

15. The device of claim 11, wherein the virtual machine interprets and executes bytecode.

16. The device of claim 11, wherein the virtual machine conforms to standards based upon a JAVA MICRO EDITION PLATFORM, and wherein each of tile speech-enabled applications is a MIDlet.

17. A method for sharing speech resources among a plurality of speech-enabled applications comprising:
a plurality of speech-enabled applications conveying resource allocation/deallocation requests to a resource controller;
the resource controller automatically allocating/deallocating a set of shared speech resources based upon requests received from the speech-enabled applications;
performing speech processing operations for the speech-enabled applications using the set of shared speech resources; and
conveying results and events produced by the performing step to applicable ones of the speech-enabled applications.

18. Tile method of claim 17, further comprising:
each of the speech-enabled applications detecting changes in application specific states, which alters a recognition search space, said recognition search space including a set of entries, where each entry matches a valid speech recognition result for which a programmatic action is associated;
each speech-enabled application conveying the search space to a grammar/words controller as the changes occur;
the grammar/words controller altering entries in a recognition vocabulary used by the set of shared speech resources, so that the recognition vocabulary is dynamically updated to include each of the entries.

19. Tile method of claim 17, wherein the speech-enabled applications execute within a virtual machine of a resource-constrained mobile communication device.

20. Tile method of claim 19, wherein the virtual machine conforms to a standard based upon a JAVA MICRO EDITION PLATFORM, and wherein each of the speech-enabled applications is a MIDlet.
